(19) United States
(12) Patent Application Publication
(10) Pub. No.: US 2019/0062007 A1
(43) Pub. Date: Feb. 28, 2019

(54) Closure With Angled Plug Seal

(71) Applicant: Silgan White Cap LLC, Downers Grove, IL (US)

(72) Inventor: Sungsuk Steve Kim, Batavia, IL (US)

(21) Appl. No.: 15/898,363

(22) Filed: Feb. 16, 2018

Related U.S. Application Data
(60) Provisional application No. 62/552,417, filed on Aug. 31, 2017.

(51) Int. Cl. B65D 41/04; B65D 45/24; B65D 1/02; B67B 3/18

(52) U.S. Cl. CPC B65D 41/0464; B67B 3/18; B65D 1/0246; B65D 45/24

(57) ABSTRACT

A closure having an angled plug seal extending from a lower surface of the top panel of the closure is provided. The outer surface of the plug is formed having an upper portion, a middle portion, a transition section and a lower portion. The upper portion, middle portion and lower portion each extend along planes that extend at differing angles relative to the vertical axis about which the closure is centered. The configuration of the outer surface of the plug allows a single closure to interchangeably be used to fluidly seal containers having any number of different container neck finish configurations.

### CROSS REFERENCE TO RELATED PATENT APPLICATION

This application claims the benefit of U.S. Provisional Application 62/552,417, titled “Angled Plug Seal and Ram Down Finish,” filed Aug. 31, 2017, which is incorporated herein by reference in its entirety.

### BACKGROUND OF THE INVENTION

The present invention relates generally to a closure having an angled plug seal configuration that allows the closure to interchangeably be fluidly sealed to a wide range of container neck finishes. Specifically, whereas traditional closure plug designs are configured to be used with and seal a single, specific type of container neck finish design (requiring multiple closure, each having different and varied plug seal designs to seal containers formed with differing neck finish designs) the design and configuration of the angled plug seal of the closure illustrated and described herein allows a single closure to be used interchangeably with any number of different container neck finishes (e.g. spin trim, chimney style ram down, ram down, etc.) made of any number of different types of materials (e.g. HDPE, PET, etc.). Additionally, the closures as described herein can be modified for use with neck finishes having any desired diameter, including but not limited to 33 mm, 38 mm, 43 mm, 48 mm, etc.

### SUMMARY OF THE INVENTION

In one embodiment a closure is centered about a vertical axis. The closure comprises a generally circular top panel having an upper surface, a lower surface and an outer periphery. A skirt extends generally perpendicularly downward from the outer periphery of the top panel. A thread is formed about an inner surface of the skirt.

A generally annular plug is attached to and extends downwards from the lower surface of the top panel. The plug is located radially inwards relative to the outer periphery of the top panel. A first portion of the plug is attached to the lower surface of the top panel and extends downwards and radially outwards at an angle of between approximately 0° and approximately 5° relative to the vertical axis. A second portion of the plug is located below the upper portion of the plug and extends downwards and radially outwards at an angle of between approximately 6° and approximately 15° relative to the vertical axis.

In one embodiment, a closure is centered about a vertical axis. The closure comprises a top panel extending along a generally horizontal plane. A skirt extends downwards from an outer periphery of the top panel. An attachment element extends from an inner surface of the skirt. The attachment element is configured to engage a corresponding attachment element on a container neck portion to attach the closure to the container.

A sealing element has an inner surface and an outer surface and extends downwardly from a lower surface of the top panel. The sealing element is located radially inwards from and concentric with the outer periphery of the top panel. The outer surface of the sealing element is defined by a first portion attached to the lower surface of the top panel and by a second portion attached to and extending downwards from a lowermost portion of the first portion. The first portion extends along a first plane at a first angle relative to the vertical axis and the second portion extends along a second plane at a second angle relative to the vertical axis. The second angle is different than the first angle.

In one embodiment, a method for providing closures for one or more containers comprises providing a first set of one or more containers. Each of the containers of the first set has a neck portion having a diameter and defining a neck finish profile configuration having a sealing surface. The neck portions of each of the containers of the first set are substantially identical.

A second set of one or more containers is also provided. Each of the containers of the second set has a neck portion having a diameter and defining a neck finish profile configuration having a sealing surface. The neck portions of each of the containers of the second set are substantially identical.

The diameter of the neck portions of each of the one or more containers of the first set is substantially the same as the diameter of the neck portions of each of the one or more containers of the second set. At least the sealing surface portion of the neck finish profile configuration defined by the neck portions of each of the one or more containers of the first set is distinct from and different than the sealing surface portion of the neck finish profile configuration defined by the neck portions of each of the one or more containers of the second set.

A first batch of one or more closures configured to seal the first set of one or more containers is also provided. Each of the closures of the first batch are substantially identical and comprise a top panel, a skirt extending downwards from an outer periphery of the top panel, and a generally annular sealing plug extending downward from a lower surface of the top panel.

A first portion of an outer surface of the sealing plug extends downwards and radially outwards from the lower surface of the top panel along a plane that extends at a first angle relative to a vertical axis about which the closure is centered. A second portion of the outer surface of the plug extends downwards and radially outwards from a lowermost portion of the first portion along a plane that extends at a second angle relative to the vertical axis.

A second batch of one or more closures configured to seal the second set of one or more containers is also provided. Each of the closures of the second batch are substantially identical and comprise a top panel, a skirt extending downwards from an outer periphery of the top panel, and a generally annular sealing plug extending downward from a lower surface of the top panel.

A first portion of an outer surface of the sealing plug extends downwards and radially outwards from the lower surface of the top panel along a plane that extends at a first angle relative to a vertical axis about which the closure is centered. A second portion of the outer surface of the plug extends downwards and radially outwards from a lowermost portion of the first portion along a plane that extends at a second angle relative to the vertical axis.

At least the dimensions and design configuration of the outer surface of the sealing plug of each of the one or more closures of the first batch is substantially identical to the dimensions and design configuration of the outer surface of the sealing plug of each of the one or more closures of the second batch.

Upon application of a first closure from either the first batch or second batch of one or more closures to a first container from the first set of one or more containers, the outer surface of the sealing plug of the first closure is configured to engage the sealing surface of the neck portion of the first container to provide a fluid-tight seal of the contents of the first container.

Upon application of a second closure from either the first batch or second batch of one or more closures to a second container from the second set of one or more containers, the outer surface of the sealing plug of the second closure is configured to engage the sealing surface of the neck portion of the second container to provide a fluid-tight seal of the contents of the second container.

### BRIEF DESCRIPTION OF THE DRAWINGS

This application will become more fully understood from the following detailed description, taken in conjunction with the accompanying figures, wherein like reference numerals refer to like elements in which:

FIG. 1A is a bottom perspective view of a closure according to one embodiment;

FIG. 1B is a cross-sectional view of the closure of FIG. 1A according to one embodiment;

FIG. 2 is an enlarged cross-sectional side view of the closure of FIG. 1B;

FIG. 3A is a cross-sectional view of a closure according to one embodiment sealingly applied to a spin-trim neck finish according to one embodiment;

FIG. 3B is an enlarged cross-sectional side view of the closure of FIG. 3A applied to the spin-trim neck finish of FIG. 3A;

FIG. 4A is a cross-sectional view of a closure according to one embodiment sealingly applied to a PET neck finish according to one embodiment;

FIG. 4B is an enlarged cross-sectional side view of the closure of FIG. 4A applied to the PET neck finish of FIG. 4A;

FIG. 5A is a cross-sectional view of a closure according to one embodiment sealingly applied to a new, modified ram down style neck finish according to one embodiment;

FIG. 5B is an enlarged cross-sectional side view of the closure of FIG. 5A applied to the new, modified ram down style neck finish of FIG. 5A;

FIG. 6A is a cross-sectional view of a closure according to one embodiment sealingly applied to a chimney style ram down neck finish according to one embodiment;

FIG. 6B is an enlarged cross-sectional side view of the closure of FIG. 6A applied to the chimney style ram down neck finish of FIG. 6A;

FIG. 7A is a cross-sectional view of a closure according to one embodiment sealingly applied to a chimney style ram down neck finish according to one embodiment; and

FIG. 7B is an enlarged cross-sectional side view of the closure of FIG. 7A applied to the chimney style ram down neck finish of FIG. 7A.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

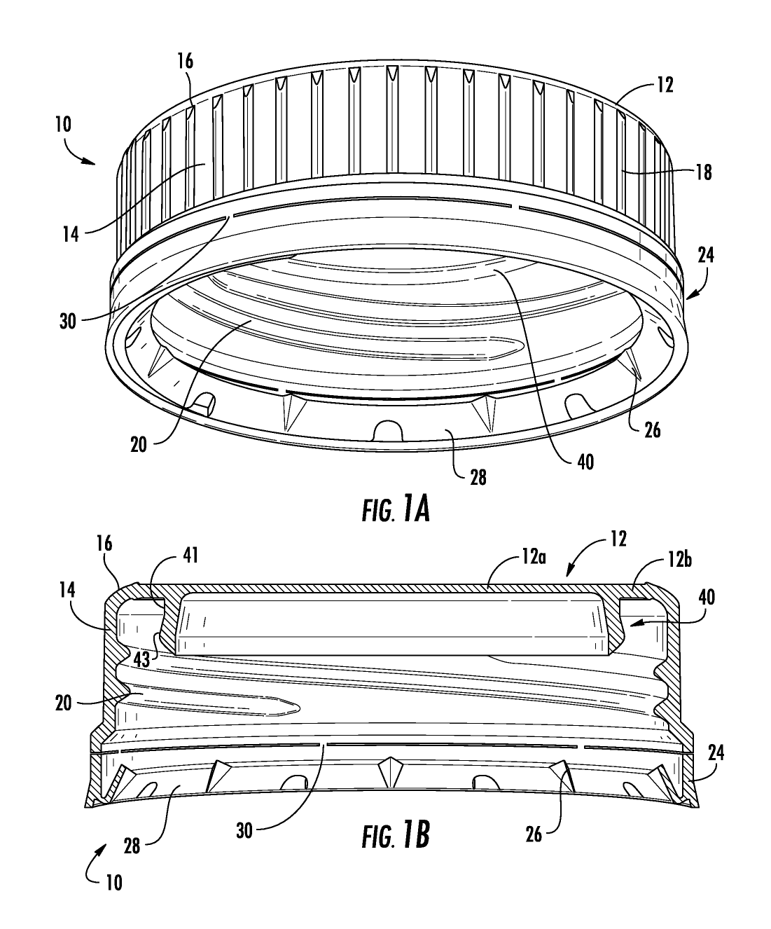

Turning to FIG. 1A, a closure 10 is shown according to an exemplary embodiment. Closure 10 includes an end wall or top portion, shown as a top panel 12. Top panel 12 is generally circular in shape and is generally planar (i.e., the outer surface of top panel 12 is flat and positioned substantially in a single plane). Closure 10 includes a sidewall, shown as skirt 14, and a transition section, shown as a corner section 16. Corner section 16 extends outwardly and downwardly from the outer, peripheral edge of top panel 12, and skirt 14 extends downwardly from the outer, peripheral edge of corner section 16.

Skirt 14 is generally annular in cross-section and is substantially perpendicular to the plane defined by top panel 12. As shown in FIG. 1A, closure 10 may also optionally include a plurality of raised ribs 18 extending radially outward from an outer surface of skirt 14. As shown in FIG. 1A, ribs 18 may extend vertically along at least a portion of the vertical length of the outer surface of skirt 14 to provide a textured or gripping surface that may facilitate opening of the closure 10.

Located along the inner surface of the skirt 14 is a container engagement structure configured to interact with a corresponding closure engagement structure located on the neck of the container to which the closure 10 is to be sealing applied. As shown in FIGS. 1A and 1B, in one embodiment the container engagement structure may comprise threading 20 that extends inwardly from the inner surface of skirt 14. Threading 20 is configured to engage corresponding threading present on the container to which closure 10 is attached. In various other embodiments, closure 10 may include any other number of types of engagement structures, such as but not limited to snap beads, lugs, etc.

In some embodiments, closure 10 may further include a tamper evidencing structure configured to provide indication to a user that the initial sealing engagement between the closure 10 and container has been disrupted as a result of the closure 10 being partially or entirely removed from the container. As shown in FIGS. 1A and 1B, in one embodiment the tamper evidencing structure may comprises a tamper band 24 coupled to a lower end of skirt 14 by series of frangible connections 30. Upon application of twisting force to closure 10 to remove closure 10 from a container, frangible connections 30 are configured to break, separating tamper band 24 from skirt 14.

As shown in FIGS. 1A and 1B, tamper band 24 may include a plurality of pleats 26 and/or a plurality of curved band sections 28. In general, pleats 26 engage cooperating structures on the neck of the container to prevent closure 10 from being removed from the container without frangible connections 30 breaking. Further, pleats 26 also facilitate application of closure 10 on to the container by allowing tamper band 24 to expand without breaking frangible connections 30.

A sealing ring, or angled plug seal 40 extends generally downward from the lower surface of top panel 12. In various embodiments, angled plug 40 is formed as an annular, uninterrupted, continuous ring or wall extending 360 degrees about the lower surface of the top panel 12. In other embodiments, the angled plug 40 is defined by a generally circumferentially extending structure formed of two or more wall segments. In such embodiments, each wall segment may be spaced apart from an adjacent wall segment by a portion of the lower surface of the top panel 12 to which no wall segments are attached.

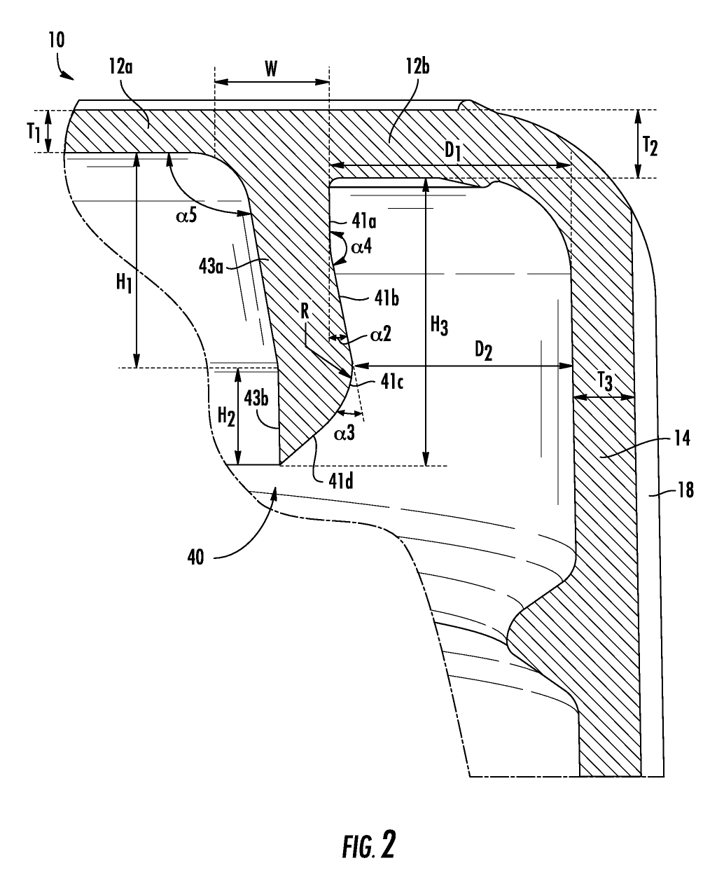

As shown in FIG. 1B and the detailed view of closure 10 of FIG. 2, in order to reduce the weight of the closure 10, a central portion 12a of the top panel 12 located radially inwards relative to the angled plug 40 may be formed having a thickness T1 that is less than the thickness T2 of an outer portion 12b of the top panel 12 located radially outwards relative to the angled plug 40. In general, the thickened end outer portion 12b of the top panel 12 provides a reinforced area that limits or prevents distortion of the top panel 12 as the angled plug 40 engages with a container neck during the application of the closure 10 to a container.

In some embodiments, the thickness T1 of central portion 12a of the top panel 12 may be between approximately 0.012 inches and approximately 0.032 inches, more specifically between approximately 0.019 inches and approximately 0.025 inches, and even more specifically approximately 0.022 inches.

In some embodiments, the thickness T2 of the outer portion 12b of the top panel 12 may be between approximately 0.025 inches and approximately 0.045 inches, more specifically between approximately 0.032 inches and approximately 0.038 inches, and even more specifically approximately 0.035 inches.

In some embodiments, the thickness T3 of the wall of the skirt 14 may be between approximately 0.022 inches and approximately 0.042 inches, more specifically between approximately 0.029 inches and approximately 0.035 inches, and even more specifically approximately 0.032 inches.

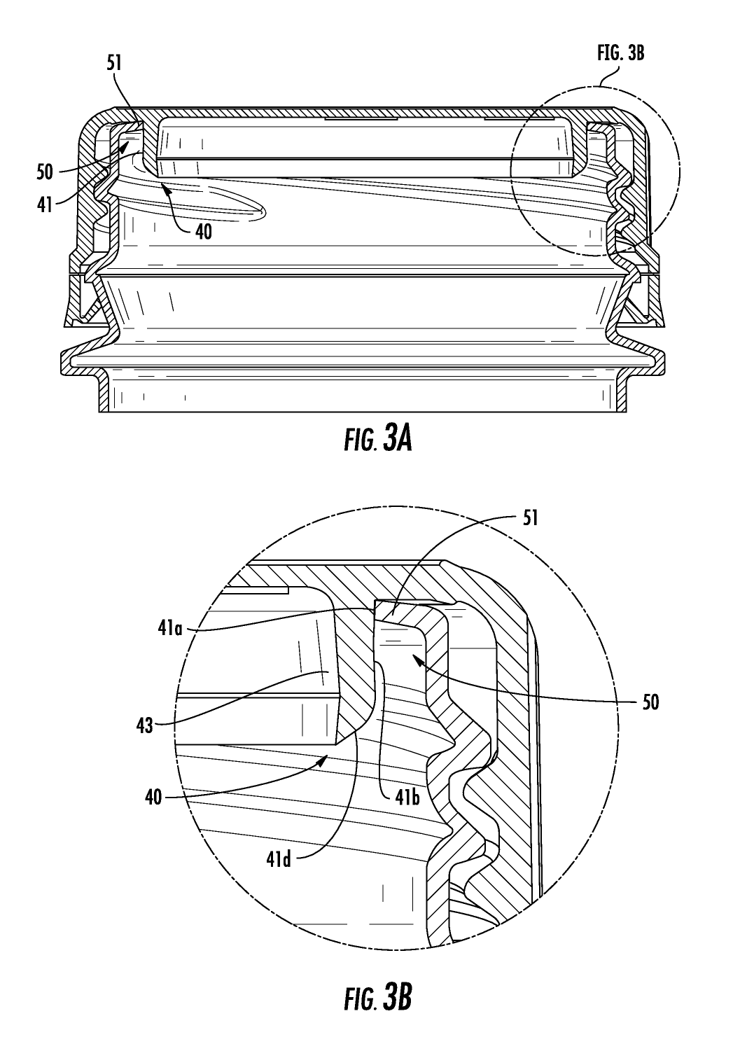

As will be understood with reference to FIG. 2, the design of the outer surface 41 of the angled plug 40 is configured to allow closure 10 to be interchangeably engaged to any number of types of container neck finishes to form a seal that prevents fluid communication with the contents of the container when the closure 10 is applied to a container. Illustrated in FIGS. 3-7 are various examples of the various types of container neck finishes that the closure 10 may be used to seal. As previously disclosed, the closure 10 may be used to seal these and other types of container neck finishes regardless of the material (e.g. PET, HDPE, etc.) from which the container neck is formed.

Turning to FIG. 2, the outer surface 41 of the angled plug 40 extends downwards from the lower surface of the top panel 12. The outer surface 41 of the plug is defined by an upper portion 41a, a middle portion 41b, a transition portion 41c, and a lower portion 41d.

As shown in FIG. 2, the closure 10 is generally centered about a vertical axis, with the upper portion 41a of the outer surface 41 of the plug 40 extending downwards from the lower surface of the top panel 12 along a first plane that extends at a first angle α1 relative to the vertical axis. The middle portion 41b extends along a second plane that extends at a second angle α2 relative to the vertical axis. The lower portion 41d extends along a third plane that extends at a third angle α3 relative to the vertical axis. A fourth angle α4 is defined between the upper portion 41a of the outer surface 41 and the middle portion 41b of the outer surface 41 of the plug seal 40.

In some embodiments, the upper portion 41a of the outer surface 41 of the plug 40 extends along a plane that is exactly or substantially perpendicular to a plane along which the top panel 12 extends. In some embodiments, the angle α1 at which the upper portion 41a of the outer surface 41 of plug 40 extends downwards and radially outwards relative to the vertical axis is between approximately 0° and approximately 10°, more specifically between approximately 0° and approximately 5°, and even more specifically between approximately 0° and approximately 3°.

As illustrated in FIG. 2, the middle portion 41b of the outer surface 41 of the plug 40 extends directly below the lowermost portion of the upper portion 41a of the outer surface 41. In some embodiments, the middle portion 41b extends along a plane that is not perpendicular to a plane along which the top panel 12 extends. In some embodiments, the angle α2 at which the middle portion 41b of the outer surface 41 extends downwards and radially outwards relative to the vertical axis is between approximately 4° and approximately 16°, more specifically between approximately 6° and approximately 14°, and even more specifically between approximately 8° and approximately 12°.

Referring again to FIG. 2, the first angle α1 along which the upper portion 41a extends relative to the vertical axis is less than the second angle α2 along which the middle portion 41b extends relative to the vertical axis. In some embodiments, the angle α4 defined between the intersection of the upper portion 41a of the outer surface 41 and the middle portion 41b of the outer surface 41 is between approximately 155° and approximately 178°, more specifically between approximately 160° and approximately 175° and even more specifically between approximately 165° and 172°.

A transition portion 41c connects the lowermost portion of the middle portion 41b to the uppermost portion of the lower portion 41d of the outer surface 41 of angled plug 40. As shown in FIG. 2, the transition portion 41c is defined by a curved surface having a radius of curvature R. In some embodiments, the radius of curvature R is between approximately 0.01 inches and approximately 0.07 inches, more specifically between approximately 0.03 inches and approximately 0.05 inches, and even more specifically approximately 0.04 inches.

As further shown in FIG. 2, the lower portion 41d of the outer surface 41 extends downwards and radially inwards relative to a vertical axis about which the closure 10 is centered. In some embodiments, the angle α3 at which the lower portion 41d of the outer surface 41 extends downwards and radially inwards relative to the vertical axis is between approximately 35° and approximately 75°, between approximately 40° and approximately 60° and even more specifically between approximately 45° and 55°.

The inner surface 43 of the angled plug 40 extends downwards from the lower surface of the top panel 12 and is defined by an upper portion 43a and a lower portion 43b. As illustrated in FIG. 2, the upper portion 43a of the inner surface 43 of the plug 40 extends downwards and radially outwards from a lower surface of the top wall 12 at an angle α5 relative to a plane along which the central portion 12a of the top panel 12 lies. In some embodiments, the angle α5 at which the upper portion 43a of the inner surface 43 extends downwards and radially outwards relative to the central portion 12a of the top panel 12 is between approximately 70° and approximately 130°, and more specifically between approximately 95° and 115°, and even more specifically approximately 100°. The lower portion 43b of the inner surface 43 of the plug 40 extends substantially perpendicularly relative to the plane along which the central portion 12a of the top panel 12 extends. The design of the inner surface 43 of the plug 40 is configured to allow the closure 10 to be removed from a mold in a single step following molding.

Turning again to FIG. 2, in some embodiments, the width W of the angled plug 40 as measured at a base portion along which the upper portion of the plug 40 is attached to the lower surface of the top panel 12 is between approximately 0.035 inches and approximately 0.055 inches, more specifically between approximately 0.041 inches and approximately0.049 inches, and even more specifically approximately 0.045 inches.

In some embodiments, the height H1 of the upper portion 43a of the inner surface 43 of the plug 40 is between approximately 0.080 inches and approximately 0.140 inches, more specifically between approximately 0.100 inches and approximately 0.120 inches, and even more specifically approximately 0.110 inches.

In some embodiments, the height H2 of the lower portion 43b of the inner surface 43 of the plug 40 is between approximately 0.010 inches and approximately 0.090 inches, more specifically between approximately 0.035 inches and approximately 0.065 inches, and even more specifically approximately 0.050 inches.

In some embodiments, the height H3 of the outer surface 41 of the plug 41 is between approximately 0.100 inches and approximately 0.200 inches, more specifically between approximately 0.125 inches and approximately 0.175 inches, and even more specifically approximately 0.147 inches.

In some embodiments, a distance D1 as measured between the uppermost portion of the upper portion 41a of the outer surface 41 of the plug 40 and the portion of the inner surface of the wall of the skirt 14 lying opposite the uppermost portion of the upper portion 41a of the outer surface 41 of the plug 40 is between approximately 0.190 inches and approximately 0.390 inches, more specifically between approximately 0.240 inches and approximately 0.340 inches, and even more specifically approximately 0.290 inches.

In some embodiments, a distance D2 as measured between the radially outermost portion of the transition portion 41c of the outer surface 41 of the plug 40 and the portion of the inner surface of the wall of the skirt 14 lying opposite the radially outermost portion of the transition portion 41c is between approximately 0.170 inches and approximately 0.370 inches, more specifically between approximately 0.220 inches and approximately 0.320 inches, and even more specifically approximately 0.270 inches.

Unlike traditional closure plug configurations, which are designed for to sealingly engage with a single, specific type of container neck finish, as illustrated by the exemplary embodiments of FIGS. 3-7, the configuration of the angled plug 40 of the closure 10 allows closure 10 to be used interchangeably with any number of different types of container neck finishes. Specifically, the varied configurations of the upper portion 41a, middle portion 41b, transition portion 41c and lower portion 41d of the outer surface 41 of the angled plug 40 provide various engagement points along which the interior of a neck finish—regardless of the type of neck finish—can interact so as to provide a fluid tight seal between the closure 10 and the container to which the closure 10 is applied.

For example, as illustrated in FIGS. 3A and 3B, the angled plug 40 is configured such that the upper portion 41a of the outer surface 41 of the plug 40 engages the generally vertically extending sealing surface 51 of a mouth portion of a container having a spin trim neck finish 50 to provide a fluid-tight seal when the closure 10 is attached to a container having such a spin trim neck finish 50.

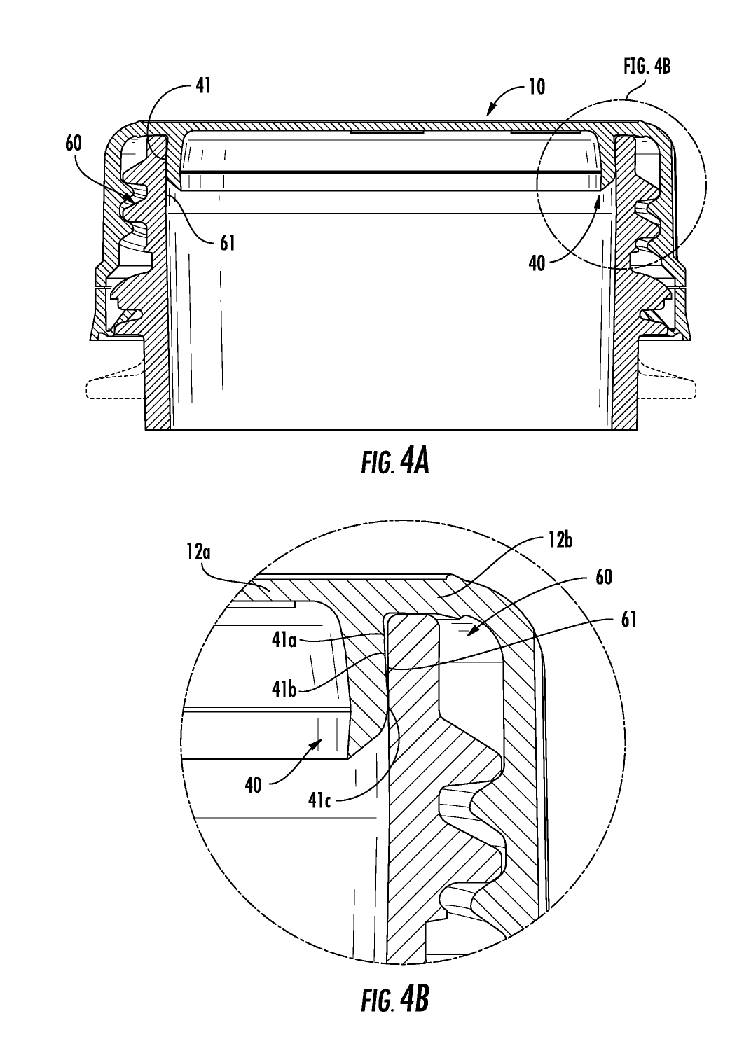

As shown in FIGS. 4A and 4B, the angled plug 40 is further configured such that the transition portion 41c of the outer surface 41 of the plug 40 engages the generally vertically extending annular inner surface 61 of a PET neck finish 60 to provide a fluid-tight seal when the closure 10 is attached to a container having such a PET neck finish 60. Transition portion 41c permits an internal diameter of annular inner surface 61 to be increased, thereby reducing the amount of PET material required to maintain a seal compared to a spin trim neck finish and/or a ram down style neck finish. It is considered that the increase in the relative diameter is between approximately 0.010 inches and approximately 0.030 inches, more specifically between approximately 0.015 inches and approximately 0.025 inches, and even more specifically approximately 0.020 inches.

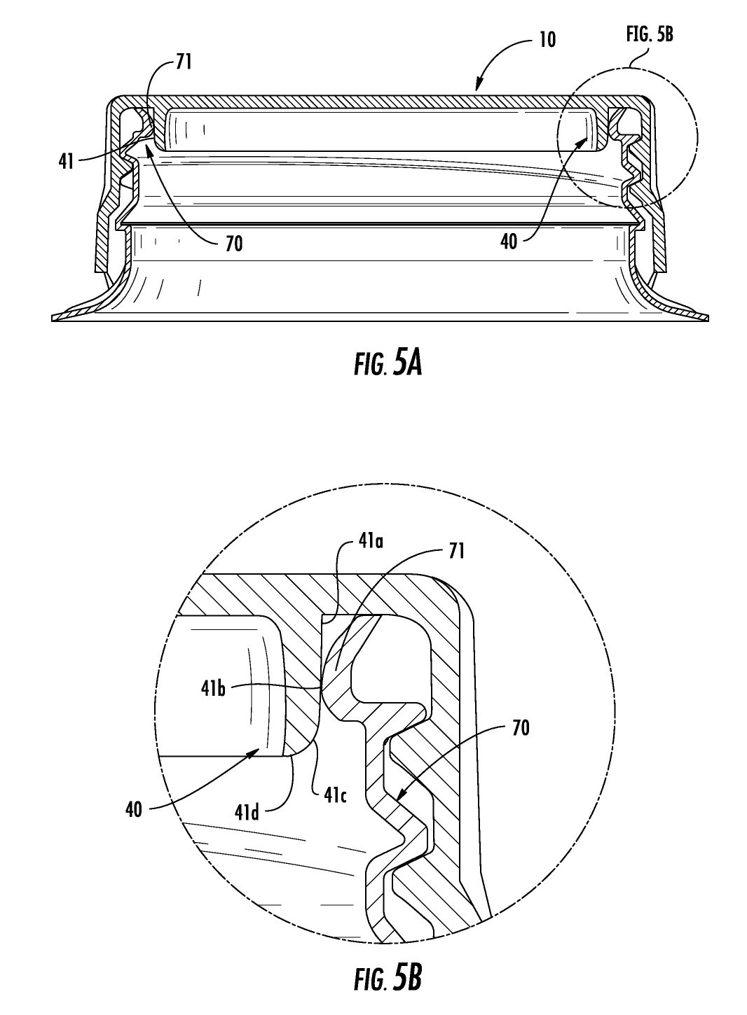

Turning to FIGS. 5A and 5B, the angled plug 40 is further configured such that the middle portion 41b of the outer surface 41 of the plug 40 engages the inwardly curved inner surface 71 of a new, modified ram down style neck finish 70 to provide a fluid-tight seal when the closure 10 is attached to a container having such new, modified style ram down neck finish 70. The tapered or flared uppermost neck opening portion of the new, modified ram down style neck finish 70 illustrated in FIGS. 5A and 5B allows for the easier pouring of contents from a container, thus providing users a better pouring experience when dispensing contents from a container. The modified ram down style neck finish 70 as illustrated in FIGS. 5A and 5B may formed having any desired neck diameters, including e.g. diameters of between 33 mm and 110 mm.

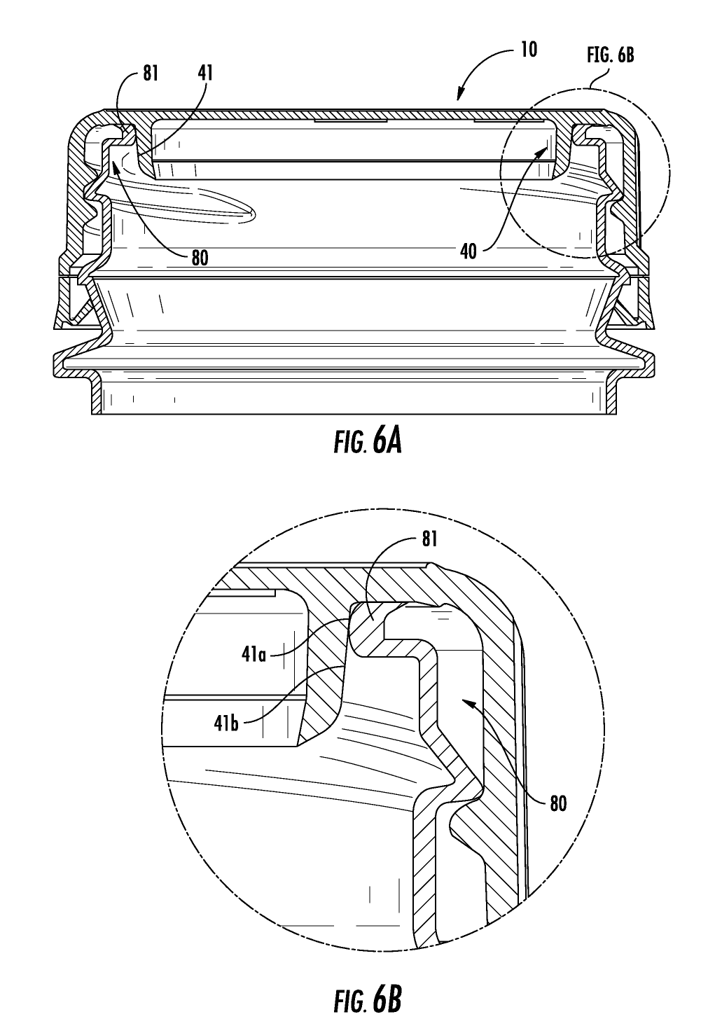

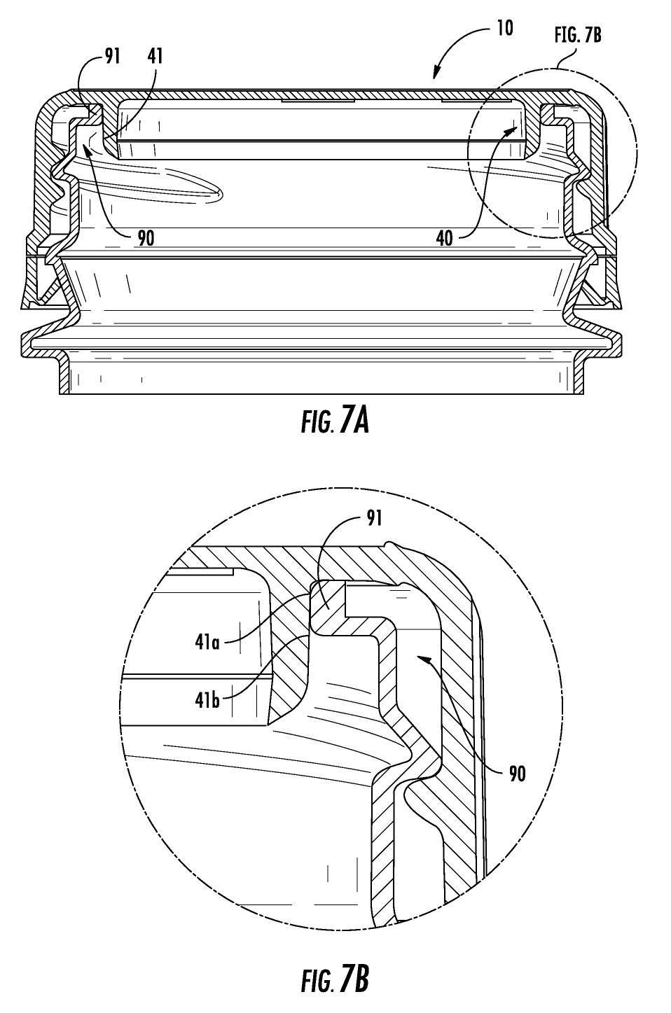

Illustrated in FIGS. 6A and 6B is one example of a chimney style ram down neck finish 80 which the closure 10 may be used to seal. Another example of a chimney style ram down neck finish 90 which the closure 10 may be used to fluidly seal is provided in FIGS. 7A and 7B. As shown by FIGS. 6 and 7, the angled plug 40 of the closure 10 also configured such that the upper portion 41a and/or the middle portion 41b of the outer surface 41 of the plug 40 engages the inwardly extending sealing surfaces 81 and 91 of the chimney style neck finishes 80 and 90 to provide a fluid-tight seal when the closure 10 is attached to a container having a chimney style neck finish, such as e.g. those chimney style ram down neck finishes 80 and 90 illustrated in FIGS. 6 and 7.

In various embodiments, the closures 10 discussed herein may be of various sizes intended to seal containers of various sizes and having various contents. In some exemplary embodiments, the closures 10 are configured to seal containers such as metal, glass or plastic containers or bottles for holding liquids, granular materials, food, etc. In various embodiments, the angled sealing plug 40 of the closures 10 discussed herein are suitable for maintaining a hermetic seal with the container neck finish to which the closure 10 is attached.

In various embodiments, closure 10 is configured to seal a container configured to hold consumable or edible products (e.g., beverages, water, food, etc.). In various embodiments, closure 10 is configured to seal a container that is a molded (e.g., blow-molded) thermoplastic beverage container configured to hermetically hold a beverage (e.g., water, juice, fortified or nutrient water, tea, sports drink, energy drink, milk, milk-based beverages, etc.). In other embodiments, closure 10 can be used to seal a wide variety of containers including pouches, jars, metal bottles, paper board cartons, etc.

In various embodiments, the closures 10 discussed herein may be formed from a plastic or polymer material. In various embodiments, the closures 10 may be formed by injection molding or by compression molding. For example, the closures 10 may be injection molded from a polypropylene homopolymer resin. In specific embodiments, the closures 10 may be made from a clear (e.g., translucent or transparent) polypropylene homopolymer resin, or they may be made from a clear random copolymer polypropylene. In various embodiments, the clear material of the closure 10 is such that the engagement structure (e.g., threading 20) is visible from the outside of the closure 10 through skirt 14.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description. It should also be understood that the terminology is for the purpose of description only and should not be regarded as limiting.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

We claim:

1. A closure centered about a vertical axis, the closure comprising:
a generally circular top panel having an upper surface, a lower surface and an outer periphery;
a skirt extending generally perpendicularly downward from the outer periphery of the top panel;
a thread formed about an inner surface of the skirt; and
a generally annular plug attached to and extending downwards from the lower surface of the top panel, the plug being located radially inwards relative to the outer periphery of the top panel;
wherein a first portion of the plug is attached to the lower surface of the top panel and extends downwards and radially outwards at an angle of between approximately 0° and approximately 5° relative to the vertical axis; and
wherein a second portion of the plug is located below the upper portion of the plug and extends downwards and radially outwards at an angle of between approximately 6° and approximately 15° relative to the vertical axis.

2. The closure of claim 1, wherein the plug further comprises a third portion extending beneath the second portion, the third portion extending downwards and radially inwards relative to the vertical axis;
wherein an uppermost portion of the third portion is attached to a lowermost portion of the second portion along a transition portion.

3. The closure of claim 2, wherein the third portion extends at an angle of between approximately 45° and approximately 55° relative to the vertical axis.

4. The closure of claim 1, wherein the closure is configured to be used to fluidly seal a container to which the closure is applied, regardless of the neck finish configuration of the container.

5. The closure of claim 1, wherein the plug is defined by an uninterrupted annular structure.

6. The closure of claim 1, wherein the closure is configured to be used interchangeably to fluidly seal containers having a spin trim neck finish, a ram down neck finish, a PET neck finish, and a chimney style ram down neck finish.

7. A closure centered about a vertical axis, the closure comprising:
a top panel extending along a generally horizontal plane;
a skirt extending downwards from an outer periphery of the top panel;
an attachment element extending from an inner surface of the skirt, the attachment element configured to engage a corresponding attachment element on a container neck portion to attach the closure to the container; and
a sealing element having an inner surface and an outer surface extending downwardly from a lower surface of the top panel, the sealing element being located radially inwards from and concentric with the outer periphery of the top panel;
the outer surface of the sealing element being defined by a first portion attached to the lower surface of the top panel and a second portion attached to and extending downwards from a lowermost portion of the first portion;
wherein the first portion extends along a first plane at a first angle relative to the vertical axis and the second portion extends along a second plane at a second angle relative to the vertical axis, the second angle being different than the first angle.

8. The closure of claim 7, wherein the second angle is greater than the first angle.

9. The closure of claim 7, wherein a third angle is defined between an intersection of the first portion and the second portion, the third angle being between approximately 160° and approximately 175°.

10. The closure of claim 7, wherein the first angle is between approximately 0° and approximately 5°.

11. The closure of claim 7, wherein the second angle is between approximately 6° and approximately 15°.

12. The closure of claim 7, wherein a thickness of a portion of the top panel lying radially inwards relative to the sealing element is less than a thickness of a portion of the top panel lying radially outwards relative to the sealing element.

13. The closure of claim 7, further comprising a third portion extending beneath the second portion, the third portion extending downwards and radially inwards relative to the vertical axis;
wherein an uppermost portion of the third portion is attached to a lowermost portion of the second portion along a transition portion.

14. The closure of claim 13, wherein a radially outermost portion of the sealing element is located along the transition portion.

15. The closure of claim 13, wherein the third portion extends at an angle of between approximately 45° and approximately 55° relative to the vertical axis.

16. A method for providing closures for one or more containers comprising:
providing a first set of one or more containers, each of the containers of the first set having a neck portion having a diameter and defining a neck finish profile configuration having a sealing surface, the neck portions of each of the containers of the first set being substantially identical;
providing a second set of one or more containers, each of the containers of the second set having a neck portion having a diameter and defining a neck finish profile configuration having a sealing surface, the neck portions of each of the containers of the second set being substantially identical;
wherein the diameter of the neck portions of each of the one or more containers of the first set is substantially the same as the diameter of the neck portions of each of the one or more containers of the second set;
wherein at least the sealing surface portion of the neck finish profile configuration defined by the neck portions of each of the one or more containers of the first set is distinct from and different than the sealing surface portion of the neck finish profile configuration defined by the neck portions of each of the one or more containers of the second set;
providing a first batch of one or more closures configured to seal the first set of one or more containers, each of the closures of the first batch being substantially identical and comprising:
a top panel;
a skirt extending downwards from an outer periphery of the top panel; and
a generally annular sealing plug extending downward from a lower surface of the top panel;
wherein a first portion of an outer surface of the sealing plug extends downwards and radially outwards from the lower surface of the top panel along a plane that extends at a first angle relative to a vertical axis about which the closure is centered and a second portion of the outer surface of the plug extends downwards and radially outwards from a lowermost portion of the first portion along a plane that extends at a second angle relative to the vertical axis;
providing a second batch of one or more closures configured to seal the second set of one or more containers, each of the closures of the second batch being substantially identical and comprising:
a top panel;
a skirt extending downwards from an outer periphery of the top panel; and
a generally annular sealing plug extending downward from a lower surface of the top panel;
wherein a first portion of an outer surface of the sealing plug extends downwards and radially outwards from the lower surface of the top panel along a plane that extends at a first angle relative to a vertical axis about which the closure is centered and a second portion of the outer surface of the plug extends downwards and radially outwards from a lowermost portion of the first portion along a plane that extends at a second angle relative to the vertical axis;
wherein at least the dimensions and design configuration of the outer surface of the sealing plug of each of the one or more closures of the first batch is substantially identical to the dimensions and design configuration of the outer surface of the sealing plug of each of the one or more closures of the second batch;
wherein, upon application of a first closure from either the first batch or second batch of one or more closures to a first container from the first set of one or more containers, the outer surface of the sealing plug of the first closure is configured to engage the sealing surface of the neck portion of the first container to provide a fluid-tight seal of the contents of the first container; and
wherein, upon application of a second closure from either the first batch or second batch of one or more closures to a second container from the second set of one or more containers, the outer surface of the sealing plug of the second closure is configured to engage the sealing surface of the neck portion of the second container to provide a fluid-tight seal of the contents of the second container.

17. The method of claim 16, wherein the neck finish profile configuration of the first set of containers is one of a spin trim, PET, ram down, or chimney neck finish.

18. The method of claim 17, wherein the neck finish profile configuration of the second set of containers is one of a spin trim, PET, ram down, or chimney style ram down neck finish.

19. The method of claim 17, wherein the shape, size and dimensions of the one or more closures of the first batch and the one or more closures of the second batch are substantially identical to one another.

20. The method of claim 19, wherein the first portions of the plug outer surfaces of the one or more closures of each the first batch and second batch extend at an angle of between approximately 0° and approximately 5°, and the second portions of the plug outer surfaces of the one or more closures of each of the first batch and second batch extend at an angle of between approximately 6° and approximately 15°.
